(19) United States
(12) Patent Application Publication
(10) Pub. No.: US 2011/0286615 A1
(43) Pub. Date: Nov. 24, 2011

(54) WIRELESS STEREO HEADSETS AND METHODS

(76) Inventors: Robert Olodort, Santa Monica, CA (US); Peter Cazalet, Campbell, CA (US); Scott Allen, Fieldbrook, CA (US)

(21) Appl. No.: 13/109,787

(22) Filed: May 17, 2011

Related U.S. Application Data
(60) Provisional application No. 61/346,001, filed on May 18, 2010.

(51) Int. Cl. H04R 5/02; H04B 3/00

(52) U.S. Cl. 381/311; 381/77

(57) ABSTRACT

Wireless stereo headsets and methods of using the headsets are described. In one embodiment, a wireless stereo headset includes a first earpiece, having a first speaker and a first USB connector, and a second earpiece which has a second speaker and a second USB connector. The USB connectors are configured to charge a battery within each earpiece without a cable to connect the earpiece to a source of power, and the earpieces are shaped to matingly engage together such that the first speaker mates with the second USB connector and the second speaker mates with the first USB connector. In one embodiment, each of the first earpiece and the second earpiece can be configured to act as master device and when one becomes the master device, the other earpiece will in response act as the slave device.

This application is related to co-pending U.S. Provisional Patent Application No. 61/346,001 filed on May 18, 2010; this application claims the benefit of the provisional's filing date under 35 U.S.C. §119(e) and is hereby incorporated herein by reference in its entirety.

### BACKGROUND OF THE INVENTION

The present invention relates to a wireless headset such as one or more earpieces that wirelessly communicate with another device.

A wireless headset, such as a wireless earpiece, provides wireless communication between the headset and another device, such as a cellular telephone, a computer, or an entertainment device (e.g. an MP3 player) or other consumer electronic devices. For example, a wireless earpiece can employ a Bluetooth wireless communication system to transmit data or voice or both wirelessly. Published US applications 2006/0025074 and 2003/0207703 and 2008/0317274 provide examples of wireless headsets that can provide wireless communication with a host device. Certain Bluetooth systems can also enable two earpieces to each operate wirelessly and communicate with a host device wirelessly. For example, one earpiece is configured to serve as a wireless master device and communicate wirelessly with the host, such as a cellular telephone or other consumer electronic device and the other wireless earpiece is configured to operate in a slave mode in which all communications from the host device are through the master device. CSR plc of Cambridge, United Kingdom provides a development kit that uses two Bluetooth devices to operate in a master/slave manner, where one device is dedicated to be the master and the other is dedicated to be the slave device.

A pair of stereo earpieces is stored in a carrier container which is designed to receive and hold both earpieces when not in use. Such an arrangement requires a user to keep the carrier container in a pocket or purse, etc. when using the stereo earpieces. Published US application 2008/0317274 provides an example of stereo earpieces which does not require a container; however, that design is predicated upon a cable (containing a set of wires) connecting the two earpieces so that the earpiece can act as a necklace or be otherwise worn around the neck of a user so that when the stereo earpieces are not in use, they can be “stored” by having them hung from the user's neck. In addition to providing a mechanical connection between the earpieces (enabling them to act as a necklace), the wires in the cable also serve as an electrical connection between the earpieces.

The prior art headsets described herein do not provide a small, elegant and simple design when the stereo earpieces are stored and also when the stereo earpieces are used.

### SUMMARY OF THE DESCRIPTION

Wireless stereo headsets and methods of using the headsets are described.

In one embodiment, a pair of wireless stereo earpieces can include a first earpiece and a second earpiece. The first earpiece can include a body having a first end and a second end and a speaker disposed near the first end of the body; the speaker is configured to create sound from an electrical output such as an output from a host device (e.g. a cellular telephone, computer, or an entertainment device or other consumer electronic devices). The first earpiece can also include a communication system which is configured to provide wireless communication with at least one of the host or the second earpiece, and the communication system is coupled to the speaker and to a microphone. The first earpiece also includes a battery coupled to the communication system to provide power to the communication system, and the first earpiece further includes a USB (Universal Serial Bus) compliant set of connectors or conductors disposed at the second end of the body, wherein the second end of the body is shaped and configured to matingly fit and engage a speaker of the second earpiece when the second earpiece is coupled to the first earpiece. The USB compliant set of connectors are coupled to the battery to charge the battery when the USB compliant set of connectors receive power from a USB compliant receptacle such as a USB port on a computer, a TV, a USB hub that is powered, etc. When the second earpiece is connected to the first earpiece, the USB compliant set of connectors of the first earpiece are disposed adjacent to the speaker of the second earpiece, and the speaker of the first earpiece is disposed adjacent to a USB compliant set of connectors of the second earpiece. In one embodiment, the earpieces are shaped to matingly engage together such that a speaker of an earpiece mates with and can cover a USB connector of the other earpiece.

In one embodiment, each of the earpieces can be charged without using a cable to directly connect the first earpiece or the second earpiece to a power source that is external to the earpiece. For example, when the source of power is a complementary set of USB connectors, such as a USB receptacle, the USB compliant set of connectors on the earpiece can be mechanically and electrically coupled to the USB receptacle without any cable intervening between the USB compliant set of connectors on the earpiece and the complementary set of USB connectors in the USB receptacle. Furthermore, the two wireless earpieces communicate with each other wirelessly and so no cable is required to connect the two earpieces when they are functioning together, such as in stereo mode.

In one embodiment, the speakers of each of the earpieces can be protected by the USB plugs of each earpiece, and similarly the USB plugs of each earpiece can be protected by the speaker of the other earpiece when the two earpieces are joined and connected together.

In one embodiment, a gap can exist between the two earpieces when they are connected together. This gap allows the earpieces to be easily separated using one's fingers and can be used to place the pair of earpieces on a keychain or on a belt loop or on a purse strap, etc. The two earpieces can be connected together through a frictional connection or can be held together by two magnets, one on each earpiece, or one magnet on one earpiece and a ferrous object which is attracted to the magnet on the other earpiece.

In one embodiment, the USB compliant set of connectors can be positioned on each earpiece such that it faces the speaker grill of the speaker of the other earpiece when the two earpieces are joined together. In an alternative embodiment, the USB compliant set of connectors can be disposed on an opposite side of the end of the earpiece which mates with the speaker of the other earpiece.

In one embodiment, each earpiece can include a visual indicator disposed on the body of the earpiece, which visual indicator is configured to indicate at least one of the charge state of the battery or the operating condition of the earpiece. Each earpiece can also include one or more sensors, such as temperature sensors, infrared sensors, proximity sensors, and ambient light sensors. These sensors can be configured, in combination with a processing system such as a microcontroller and a non-transitory machine readable storage medium, such as flash memory or other semiconductor memory, to enable the earpiece to determine when it is separated from the other earpiece and to also enable each earpiece to determine whether it has been attached to an ear, etc.

In one embodiment, the end of the body of an earpiece, which is adjacent to the USB compliant set of connectors of the earpiece, can have a rounded edge at the periphery of that end of the body, and this rounded edge can be matched in size and shape to the round contour of a speaker of the other earpiece.

In one embodiment, each of the earpieces in the pair of wireless stereo earpieces can be configured to act as a master device to receive wirelessly communication signals from a host device, such as a cellular telephone, computer or other consumer electronic device, and to transmit wirelessly signals to the other earpiece which is configured to act as a slave device relative to the master device. In other words, each is capable of becoming the master device and no one earpiece is predetermined to be the master device. In this embodiment, the master device provides wireless two-way communication between itself and the host, and the master device provides at least one-way communication to the slave device, such that signals (intended for the slave device) from the host device are transmitted through the master device and then to the slave device.

In one embodiment, the present invention includes a method for using a wireless stereo headset having a pair of earpieces which are a first earpiece and a second earpiece, wherein the method includes connecting together the first earpiece and the second earpiece. The first earpiece includes a first speaker and a first USB compliant set of connectors and the second earpiece includes a second speaker and a second USB compliant set of connectors. The first speaker covers the second USB compliant set of connectors when the first and the second earpieces are connected together, and the second speaker covers the first USB compliant set of connectors when the first and the second earpieces are connected together. The method further includes separating the first earpiece and the second earpiece, wherein the separating action exposes the first USB compliant set of conductors or connectors and the second USB compliant set of conductors or connectors.

In another embodiment, a method of using the wireless stereo headset having a pair of earpieces which includes a first earpiece and a second earpiece includes detecting a separation of the first earpiece and the second earpiece from a state in which the first earpiece and the second earpiece were connected together. The headset can then take certain actions after detecting the separation, such as, for example, automatically answering a telephone call in response to detecting the separation or automatically powering up both earpieces so that they can be used in stereo mode, etc. This method can further include detecting, after the separation, that the first earpiece has been attached to an ear and then determining whether or not the second earpiece has been attached to an ear. This determination can be made, for example, by one or more of the sensors described herein, such as an infrared sensor to sense body heat, etc. If it has been determined that the second earpiece has not been attached to an ear after detecting the separation, then in one embodiment the method automatically sets the first earpiece to act as a mono headset while the second earpiece is placed in a low power state. On the other hand, if the second earpiece has detected that the second earpiece has been attached to an ear after detecting the separation, then the method can include automatically setting the first and second earpieces to operate in a stereo mode. This method may utilize a timer which allows a system to give the user some time to place both earpieces in an ear or otherwise attach them to the ear. After the timer expires, the system can then determine the state of the two earpieces and select between stereo mode and mono mode.

In another embodiment, a stereo wireless headset includes a housing having a first chamber and a second chamber, and a USB compliant connector which is moveably coupled to the housing. The first chamber is designed to removably hold a first earpiece which includes a first battery and a first set of connectors configured to receive power to recharge the first battery while the first earpiece is within the first chamber. The second chamber is configured to hold a second earpiece which is removably disposed within the second chamber, wherein the second earpiece includes a second battery and a second set of connectors which are configured to receive power to recharge the second battery while the second earpiece is within the second chamber. The housing can also include a third battery which is attached to the housing and which is electrically coupled to the USB compliant connector to be charged by power received through the USB compliant connector. The third battery can be electrically coupled to the first set of connectors to charge the first battery when the first earpiece is disposed in the first chamber, and the third battery can be electrically coupled to the second connectors to charge the second battery of the second earpiece when the second earpiece is disposed in the second chamber. The USB compliant connector can be moveably coupled to the housing by a rotatable mechanism such as a hinge or a slideable mechanism which allows the connector to slide in and out of the housing to expose the USB compliant connector to allow it to be connected to a USB port.

The present invention also optionally includes machine readable non-transitory storage medium which are used to store one or more computer programs having instructions which, when executed by a data processing system, can perform one or more of the methods described herein.

Other embodiments, including systems, wireless headsets, and methods for using wireless headsets, are also described herein.

### BRIEF DESCRIPTION OF THE DRAWINGS

The present invention is illustrated by way of example and not limitation in the figures of the accompanying drawings in which like references indicate similar elements.

FIG. 1 shows a side view of a stereo wireless headset that includes a first earpiece and a second earpiece connected together.

FIG. 2 shows the wireless stereo headset of FIG. 1 after the first and the second earpieces have been separated such that they are no longer connected together, and in this form they can be each separately attached to an ear of the user.

FIG. 3 shows a back view of one of the earpieces of FIG. 1.

FIG. 4 shows a front view of one of the earpieces of FIG. 1.

FIG. 5 shows an earpiece in a back view, which earpiece is similar to the earpiece 12 shown in FIG. 1 except that the set of USB compliant conductors is on the back side of the earpiece.

FIG. 6 shows a front view of the earpiece shown in FIG. 5.

FIG. 7A shows an example of a system which can be implemented within an earpiece, such as the earpiece 12 and the earpiece 14 shown in FIG. 1.

FIG. 7B is an example of a system which can be implemented within an earpiece described herein, such as earpieces 12 and 14 of FIG. 1.

FIG. 8A shows an example of a wireless headset which includes a first earpiece and a second earpiece which are connected together in a fashion which is similar to the way that the earpieces are connected together in FIG. 1. FIG. 8A shows a side view of the two earpieces connected together.

FIG. 8B is a perspective view of the two earpieces of FIG. 8A connected together.

FIG. 8C shows, in a perspective view, the earpieces of FIG. 8A after they have been separated.

FIG. 8D shows an earpiece of FIG. 8A after the earpiece has been separated from the other earpiece of FIG. 8A and then plugged into a USB receptacle to charge the battery within the earpiece shown in FIG. 8D.

FIG. 8E is a top view of the two earpieces of FIG. 8A.

FIG. 8F is a perspective front view of one of the earpieces of FIG. 8A.

FIG. 8G is a back perspective view of one of the earpieces shown in FIG. 8A after the earpiece has been separated from its corresponding earpiece.

FIG. 8H is an end view of one of the earpieces shown in FIG. 8A.

FIG. 8I is another end view of one of the earpieces shown in FIG. 8A.

FIG. 8J is a side view of one of the earpieces shown in FIG. 8A.

FIG. 8K is a top view of one of the earpieces shown in FIG. 8A.

FIG. 8L is another side view of one of the earpieces shown in FIG. 8A.

FIG. 9 is a flow chart which shows a method according to one embodiment of the present invention.

FIG. 10 is a flow chart which shows an embodiment of another method according to an embodiment of the present invention.

FIG. 11A shows another embodiment of a wireless headset which can be a pair of stereo wireless earpieces contained within a housing which includes a USB connector.

FIG. 11B shows the wireless headset after the USB connector has been retracted into the housing.

FIG. 12 shows a system which may be contained within each of the earpieces shown in FIGS. 11A and 11B.

FIGS. 13A, 13B, 13C, 13D and 13E show different views of another embodiment of a wireless headset that includes a pair of stereo wireless earpieces contained within a housing which includes a USB connector.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment. The processes depicted in the figures that follow are performed by processing logic that comprises hardware (e.g. circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

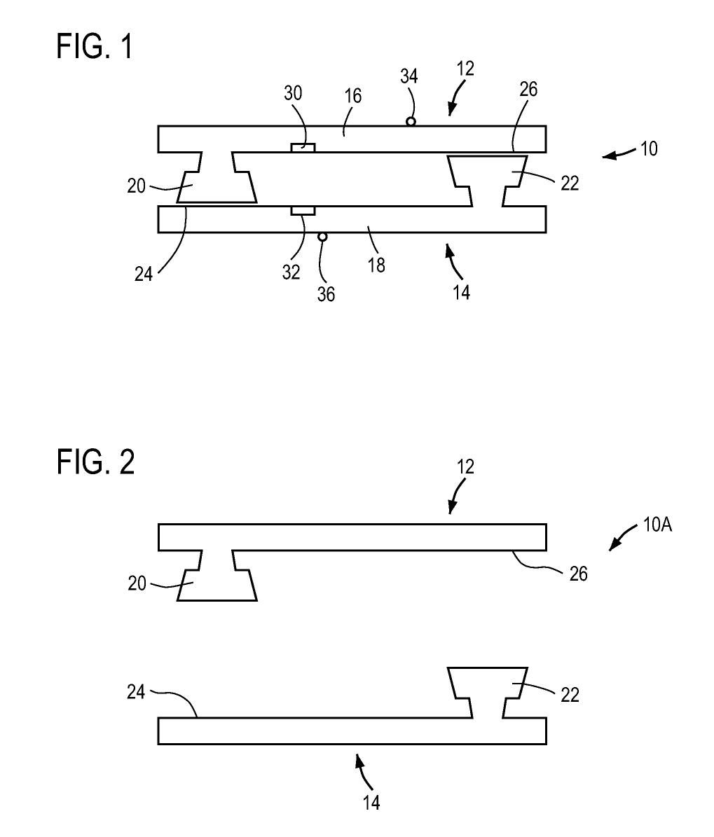

FIG. 1 shows a side view of a wireless headset 10 which includes earpiece 12 and earpiece 14 connected together in the manner shown in FIG. 1. The connection between the two earpieces may be one or both of a frictional fit between respective components on the earpieces or one or more magnets and one or more ferrous objects or other materials that are attracted to a magnet. Earpiece 12 includes a body 16 having a first end (shown on the left side of body 16) which is near first speaker 20 of the earpiece 12. Body 16 includes a second end which is opposite the first end on the right side of body 16 as shown in FIG. 1. The second end of body 16 includes, in one embodiment, a USB (Universal Serial Bus) compliant set of connectors or conductors disposed at the second end of the body. In one embodiment, this USB compliant set of conductors faces the speaker grill of speaker 22 of earpiece 14. In another embodiment, the USB compliant set of conductors is on the opposite side of body 16 facing away from the grill of speaker 22 (e.g. see the embodiment shown in FIGS. 5 and 6). Body 16 of earpiece 12 also includes one or more visual indicators, such as one or more LEDs (Light Emitting Diodes) which can provide a visual indication of one or more conditions, such as the state of charge of a battery of the earpiece 12 and/or the operating condition of the earpiece 12. Body 16 can also include a magnet or a ferrous object or other material which is attracted to a magnet. In one embodiment, earpiece 12 is a left channel stereo Bluetooth wireless earpiece which is paired, using a mechanism in Bluetooth which is known in the art, with earpiece 14 which is a right channel stereo wireless Bluetooth earpiece.

Earpiece 14 includes a body 18 having a second end on the left side of body 18 and a first end on the right side of body 18. A speaker 22 is disposed on the first end of body 18, and the grill of that speaker faces one side of the second end of earpiece 12 as shown in FIG. 1. A side of the second end of body 18 faces the grill of speaker 20 of earpiece 12. In one embodiment, a second USB compliant set of conductors or connectors is disposed on the second end of body 18 and can face the grill of speaker 20 such that the speaker covers the second USB compliant set of conductors or connectors while the speaker 22 covers the first USB compliant set of conductors or connectors. Earpiece 14 also includes a visual indicator 36 which may be one or more LEDs that can indicate one or more of the state of charge of the battery of earpiece 14 and the operating condition of the earpiece 14. Body 18 can also include a magnet or ferrous object or other material attracted to a magnet, such as magnet 32 or ferrous object 32, etc. Each earpiece 12 and 14 can include a magnet or, in another embodiment, one earpiece can include a magnet and the other earpiece can include a ferrous object or other material which is attracted to a magnet. The two magnets or the one magnet and the ferrous material or other material can have a size and strength such that they can sufficiently hold together the pair of earpieces when they are connected together when the earpiece is in a pocket or in a purse or in a briefcase, etc. but that they not be too strong to prevent a user from pulling them apart during normal use. When the two earpieces are connected together as shown in FIG. 1, a gap can exist between the two earpieces, and this gap can be used to place the earpieces, when connected together, on a keychain or on a belt loop or on a purse strap, or a chain, etc. In the embodiment shown in FIG. 1, and in other embodiments described herein, there is no need to have a wire connect the two earpieces. Each earpiece is wireless, where, in one embodiment, one earpiece can be established to be a master device and the other earpiece can be established to be a slave device to allow wireless communication with a host device such as a cellular telephone, a computer or an entertainment device (e.g. an MP3 player such as an iPod, etc.) or other consumer electronic device. The earpieces can be used to have a binaural telephone call or to listen to music in a stereo mode or a mono mode or to listen to a game, etc. It can be seen from FIG. 1 and from the other figures of the embodiment shown in FIG. 1, such as FIGS. 2, 3, and 4, that there is no ear hook on the earpiece which can be used to attach the earpiece to an ear. An example of an ear hook is shown in FIG. 1 of published US Application 2006/0025074. It will be appreciated that in an alternative embodiment, each earpiece, such as earpieces 12 and 14, can include an ear hook.

In the embodiment shown in FIG. 1, the USB compliant set of conductors 26 faces the speaker grill of speaker 22 while the USB compliant set of conductors 24 faces the speaker grill of speaker 20 when the two earpieces are connected together. When the two earpieces are separated, as shown in FIG. 2, then the USB compliant set of conductors 24 and 26 become exposed and then can be used to charge the battery within each of the earpieces as described further below. Hence, when the earpieces are connected together and not being used, both speakers are protected and both sets of conductors are protected from fingerprints, smudges, and the environment in general. Once the earpieces 12 and 14 are separated to create the wireless headset 10A, then they can each be used in a mono mode or when they are both used, then they can be used in a stereo or binaural mode.

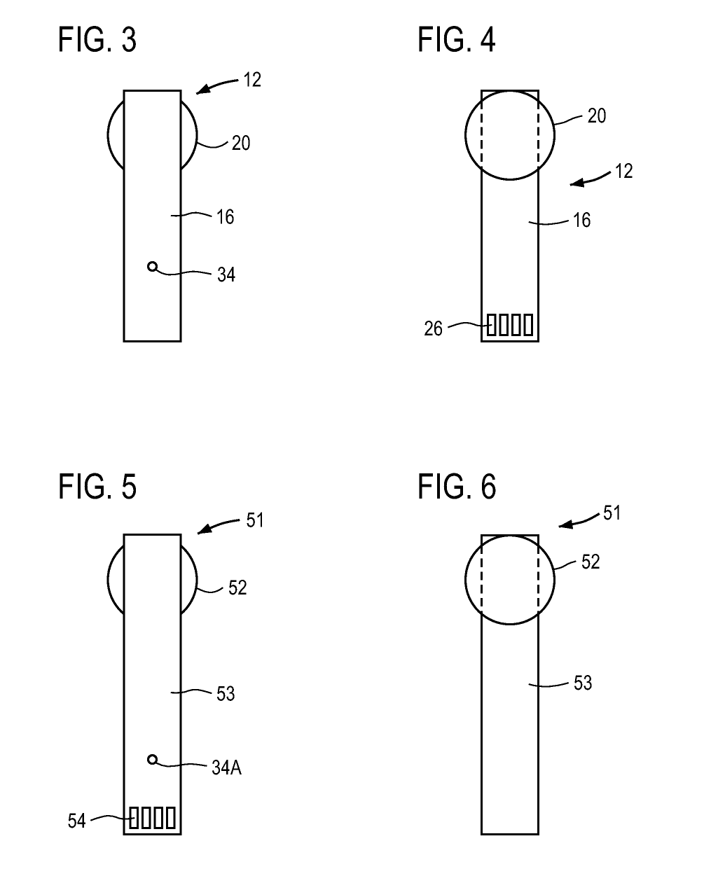

FIGS. 3 and 4 show a back view and a front view, respectively, of earpiece 12. Only a portion of speaker 20 can be seen from the back view of FIG. 3 while speaker 20 obscures a portion of body in the front view of FIG. 4. The back side of body 16 is shown in FIG. 3 and includes one or more visual indicators, such as the visual indicator 34 which may be an LED that indicates the charge state of the battery or the operating condition of earpiece 12 or both. FIG. 4's front view shows four USB compliant conductors or connectors 26 at the bottom of the body 16. The four USB compliant conductors can be utilized when earpiece 12 includes a flash memory (a form of an electrically erasable semiconductor memory) or other storage mechanism, in which case the earpiece 12 can function as a USB flash drive to store data from a computer or other data processing system. In one embodiment, the four USB compliant conductors can be used as connectors to update the firmware of the earpiece (e.g. firmware stored in memory 205) when the earpiece is plugged into a computer's USB port. In an alternative embodiment, the set of USB compliant conductors may be merely two conductors designed to receive power from a USB port on a computer, etc. to thereby charge the battery within the earpiece 12. It will be understood that earpiece 14, in at least certain embodiments, is identical to earpiece 12 except that one earpiece is designated to be a left channel and the other earpiece is designated to be a right channel. Each earpiece may be marked with indicia to indicate its channel (e.g. one earpiece has the letter “L” and the other earpiece has the letter “R”). While not shown on earpieces 12 and 14, each earpiece may also include one or more buttons or touchpads or other user controls, such as an on/off button, an answer button, one or more volume buttons, etc. These buttons can be coupled, as is known in the art, to an interface unit such as an input/output (I/O) controller.

It can be seen from FIGS. 1, 2, 3, and 4 that each earpiece includes an elongate body coupled to a speaker and extending from the speaker to a set of USB compliant set of conductors. The elongate body has a first side on which the first speaker and the first USB compliant set of conductors are disposed and a second side which is opposite the first side and which does not include the first USB compliant set of conductors and does not include a speaker. When the speaker of an earpiece is attached to an ear, the first side is next to a user's face and the second side is facing away from the user's face. An opening (not shown) on each earpiece 12 and 14 for a microphone can be disposed on the first side near the USB compliant set of conductors.

FIGS. 5 and 6 show in back and front view, respectively, an alternative embodiment of an earpiece, which is similar to earpiece 12 or earpiece 14 except that the USB compliant set of conductors or connectors is on a side of the body which is opposite the side on which the speaker is disposed. In all other respects, the earpiece shown in FIGS. 5 and 6 is similar to earpiece 12 or earpiece 14 of FIGS. 1, 2, 3, and 4. Earpiece 51 includes speaker 52 disposed at the top of body 53 as shown in FIG. 5 and FIG. 6. Earpiece 51 also includes a visual indicator 34A which can be an LED or other visual indicator to indicate one or more conditions of earpiece 51. Four conductors on the back side of body 53 form a USB compliant set of conductors 54 which can be used to charge the battery of earpiece 51 or to transfer data to and from a flash memory or other memory device within earpiece 51.

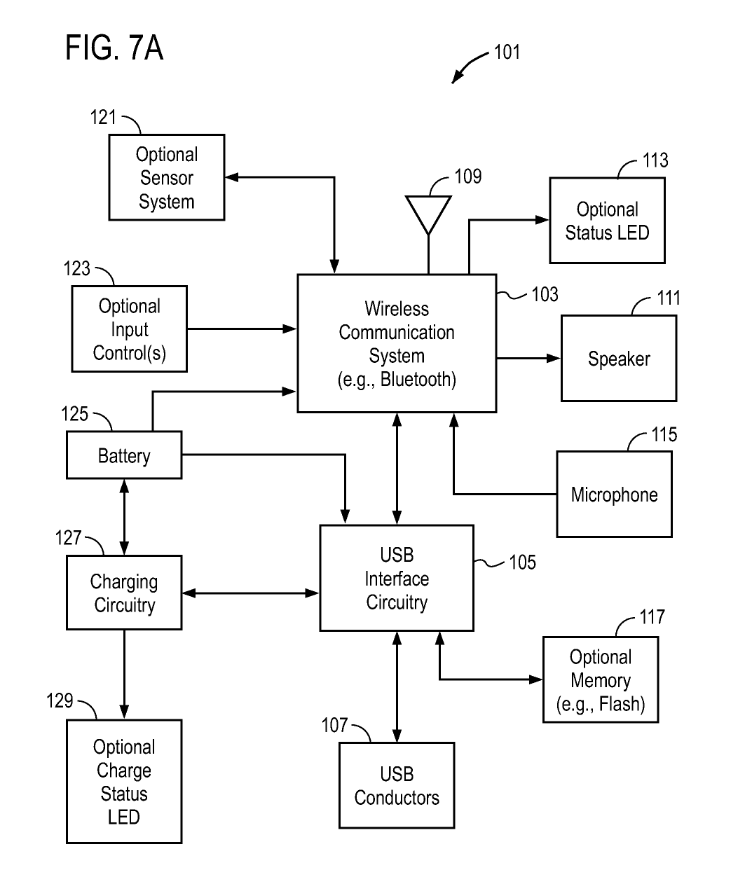

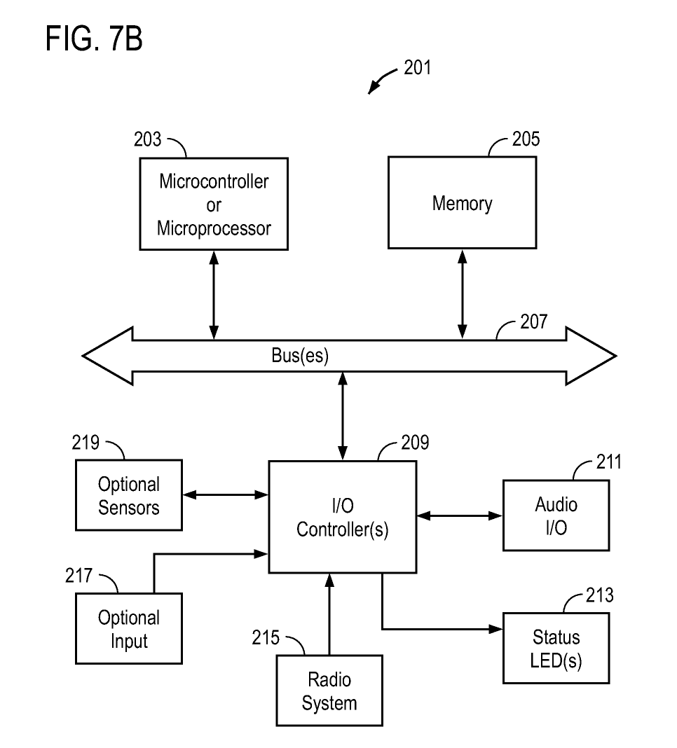

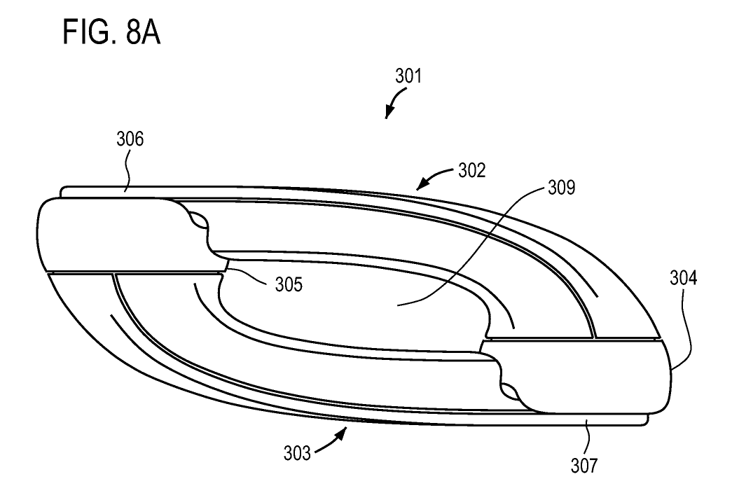

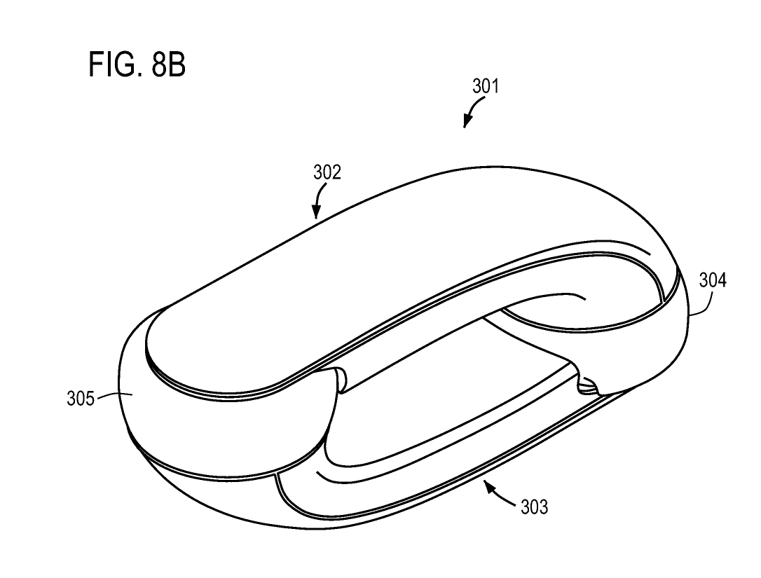

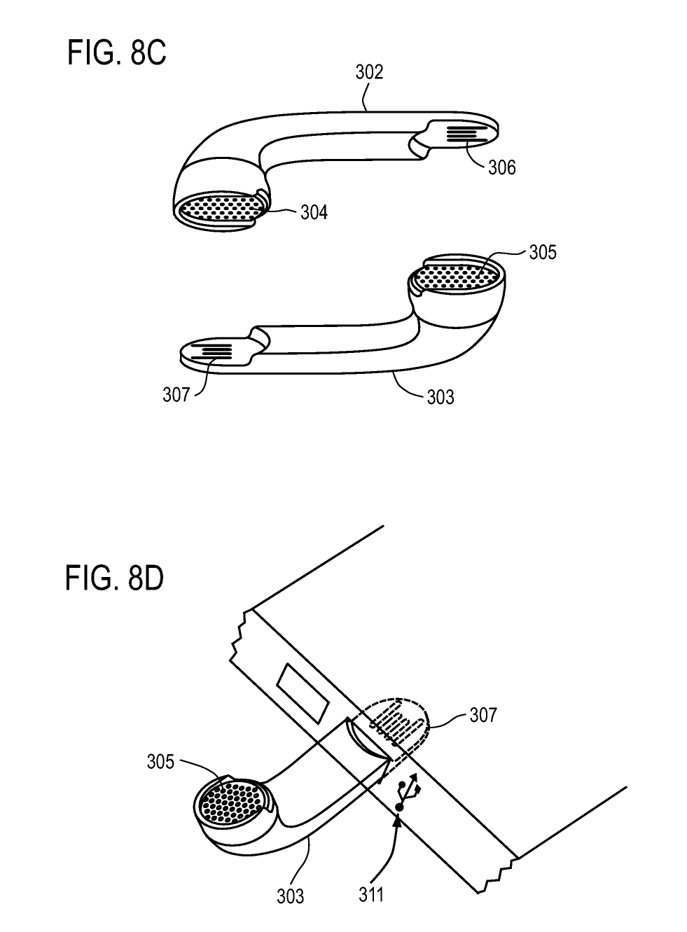

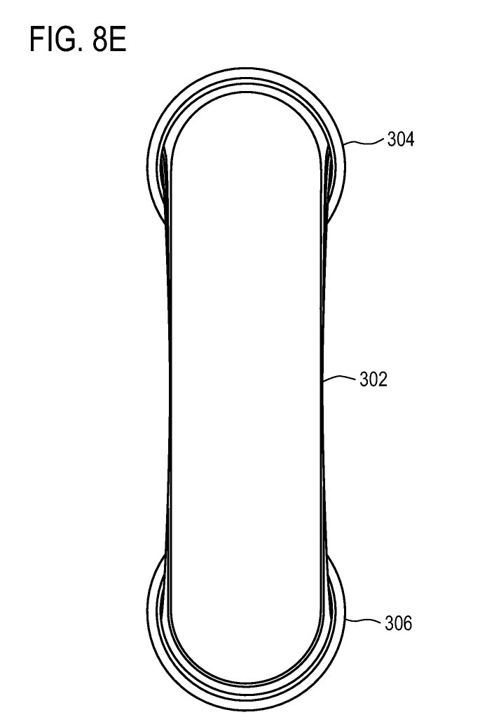

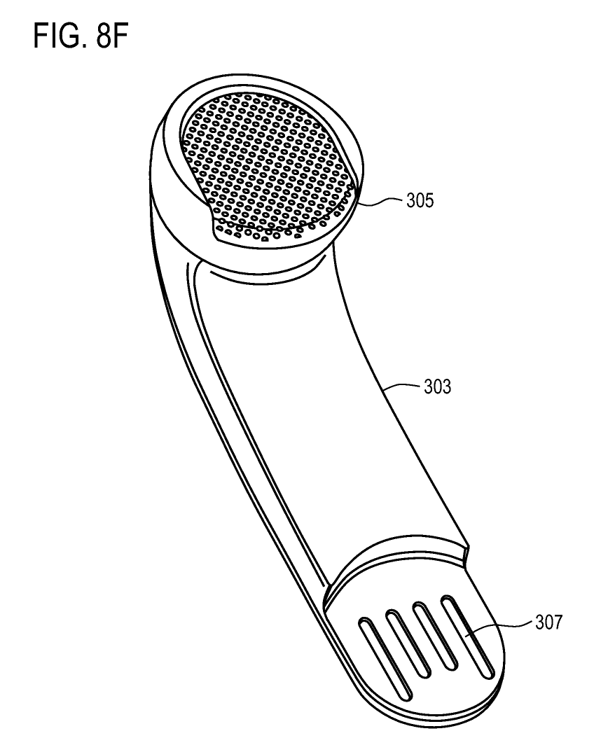

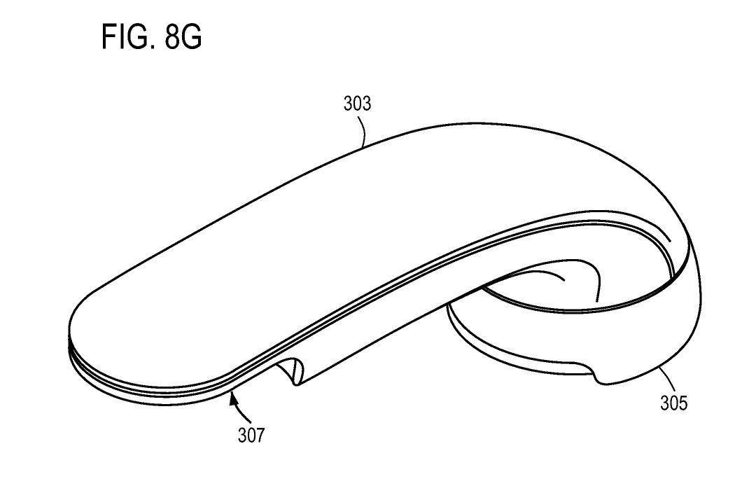

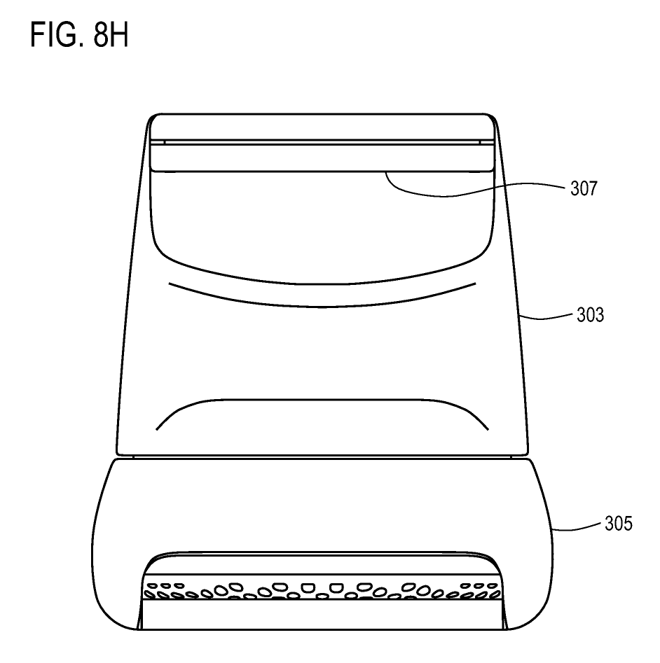

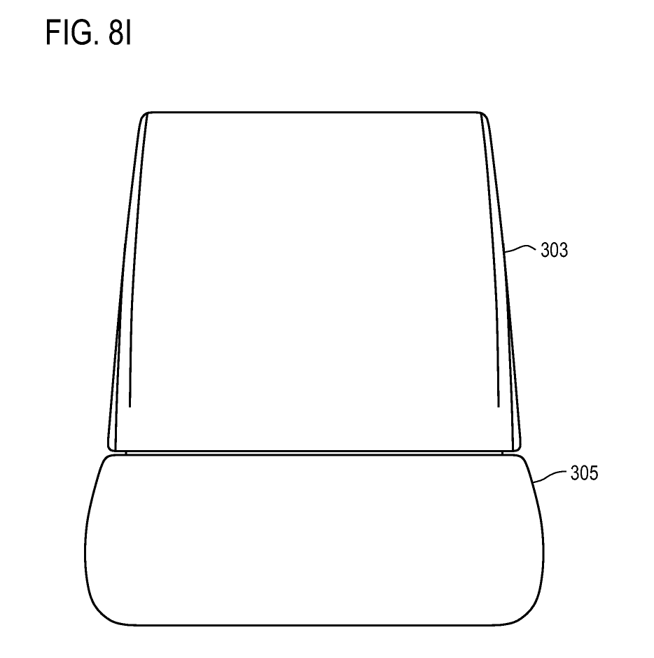

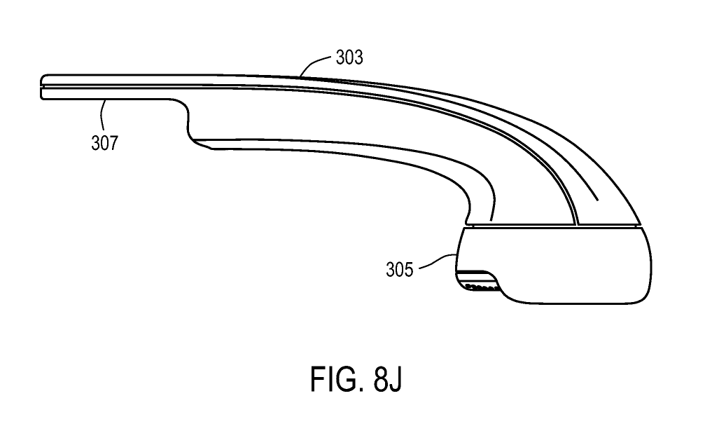

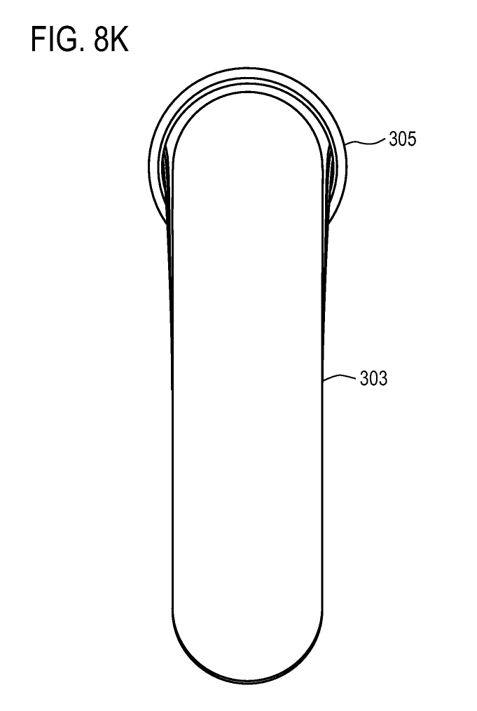

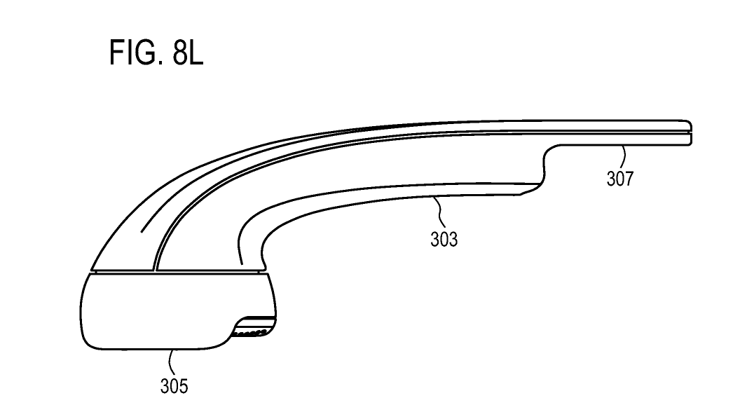

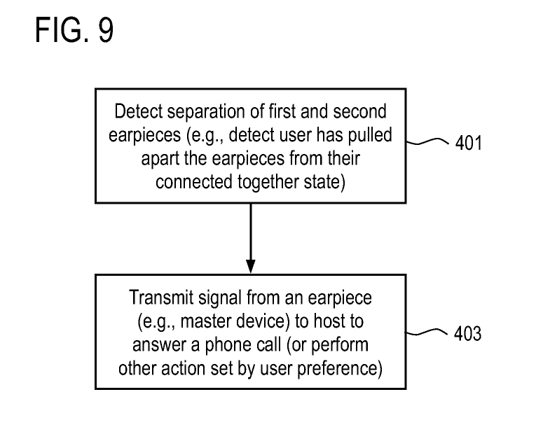

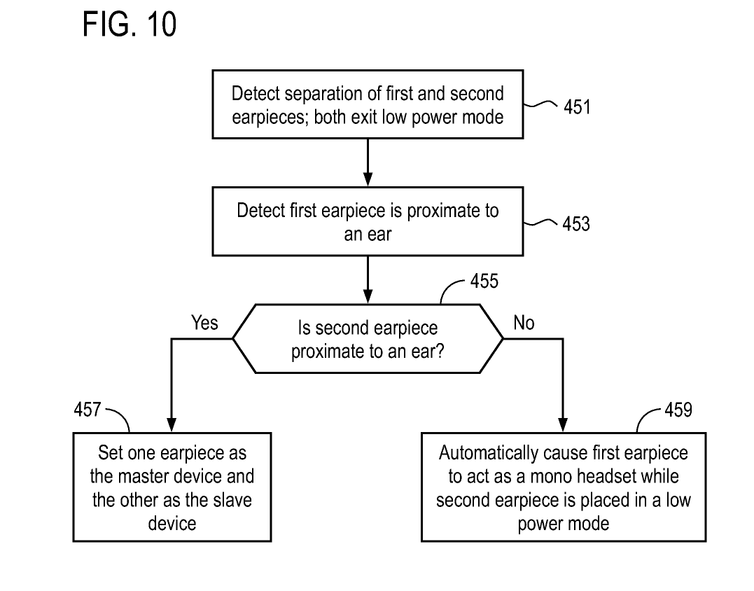

FIG. 7A shows a system 101 which can be implemented within earpieces 12 and 14 or the earpiece 51 or the earpiece 302 and the earpiece 303. Moreover, the system 101 can perform one or more of the methods described herein, such as the method shown in FIG. 9 or the method shown in FIG. 10, etc. In one embodiment, each of earpieces 12 and 14 (or each of earpieces 302 and 303) can include system 101 and be identical to each other except that one is configured as a left channel device in stereo mode and the other is configured as a right channel device in stereo mode, and each can be configured to operate as a mono phone earpiece (because each has its own microphone), and each can be configured as either a master device or a slave device when in stereo mode. System 101 can include a wireless communication system 103; in one embodiment, wireless communication system 103 can be a Bluetooth chipset or can be a Bluetooth chipset and other components to provide other types of wireless communication such as WiFi, etc. The system 103 can include, in one embodiment, a microcontroller or microprocessor 203, a memory 205, one or more buses 207, one or more I/O controllers 209, and a radio system 215 as shown in FIG. 7B. The system 103 can include one or more antennas 109 which are designed and configured to provide wireless connections to a host device, such as a cellular telephone or an entertainment device, and to also provide wireless communication to another earpiece in the wireless headset. The system 103 is coupled to, in one embodiment, USB interface circuitry 105 which in turn is coupled to USB conductors 107 which can be the USB compliant set of conductors 24 or 26 or 54 or 306 or 307 which are shown and described herein. The connection between USB interface circuitry 105 and the system 103 can be used by system 103 to cause it to enter a low power state when it determines that the USB interface, through conductors 107, has been coupled to a power source to charge battery 125. In this manner, system 103 can intelligently determine that it should be in a low power state while the battery 125 is being charged through the use of a USB port such as USB port 311 shown in FIG. 8D. Battery 125 is contained within an earpiece and is used to power, in one embodiment, all components such as system 103 and circuitry 105 as well as all other components requiring power, such as the flash memory 117, the LEDs 113 and 129, and the sensor system 121 and the input controls 123. Interface circuitry 105 is coupled to a charging circuitry 127 which charges battery 125 when the USB conductors 107 are electrically coupled, without a cable, to a USB receptacle such as USB port 311 shown in FIG. 8D. Charging circuitry 127 can be coupled to an optional charge status LED 129 to indicate the charge status of battery 125.

System 101 can include an optional sensor system 121 which is coupled to system 103 to allow the earpiece to operate according to one or more of the methods described herein, such as the method shown in FIG. 9 or the method shown in FIG. 10. In one embodiment, the sensor system can include one or more of a proximity sensor, an ambient light sensor, a pressure sensor, a temperature sensor, or an infrared sensor to sense body heat or other sensors using electrical, electrostatic, magnetic, light or sound properties. For example, in one embodiment, a combination of a proximity sensor and another sensor can be used to detect when earpiece 12 or earpiece 14 or earpiece 51 or the earpieces shown in FIG. 8A are attached to an ear. The optional sensors 219 of FIG. 7B can be the same as the optional sensor system 121 of FIG. 7A. Optional input controls 123 can be one or more input controls such as an on/off button or volume buttons or an answer button, or a touchpad(s) etc. which are coupled to provide an input to system 103. In one embodiment, the optional input 217 shown in FIG. 17B can be the same as the optional input controls 123 of FIG. 7A.

The wireless communication system 103 is also coupled to a speaker 111 to provide an audio output to a user, and the system 103 also includes a microphone 115 which provides an audio input to system 103. The audio I/O 211 of FIG. 7B can be the same as speaker 111 and microphone 115 of FIG. 7A. The system 101 which is included within an earpiece can also include one or more optional status LEDs 113 which are coupled to system 103; these status LEDs can indicate the operating status (e.g. on or off or call on hold, etc.) of the earpiece. It will be appreciated that fewer components than shown in FIG. 7A may be implemented within an earpiece. For example, the flash memory or other memory 117 may be omitted from an earpiece and other components shown as optional may also be omitted. It will also be appreciated that, in some embodiments, some of the optional components are included and other optional components are not included.

FIG. 7B shows a system 201. A portion of this system may be implemented within the wireless communication system 103. For example, the microcontroller or microprocessor 203 and the memory 205 and the one or more buses 207 and the I/O controllers 209 and the radio system 215 may be implemented within the wireless communication system 103. The microcontroller or microprocessor 203 may be a conventional microcontroller or microprocessor which is coupled through one or more buses 207 to memory 205. One or more I/O controllers 209 are coupled to the microcontroller or microprocessor 203 and memory 205 through the one or more buses 207 in order to provide input and output through the system, such as receiving audio from a microphone or outputting audio to a speaker or receiving data from optional sensors or signals from optional input such as optional sensors 219 and optional input 217 respectively. Radio system 215 can be a Bluetooth radio or a combination of a Bluetooth radio and a WiFi radio, etc. Memory 205 can be used to store computer program instructions, and it will be appreciated that memory 205 could be a semiconductor memory or other machine readable non-transitory storage media that can store the computer program instructions and, when those computer program instructions are executed by, for example, microcontroller 203, it causes the system 201 to perform one or more of the methods described herein, such as the method shown in FIG. 9 or the method shown in FIG. 10.

FIG. 8A shows a side view of two earpieces connected together. Body 302 of the first earpiece includes speaker 304 at one end of body 302 and includes a USB compliant set of conductors 306 at the other end of body 302. Wireless headset 301 also includes the second earpiece which has body 303 and speaker 305 and a USB compliant set of conductors 307. Speaker 305 is disposed at one end of body 303 and the USB compliant set of conductors 307 is disposed at the other end of body 303. The first and second earpieces form a gap 309 between the earpieces. It can be seen that both USB compliant set of conductors 306 and 307 are not exposed because they are covered by the speaker grill of speakers 304 and 305. In particular, the grill of speaker 304 of the first earpiece covers the USB compliant set of conductors 307 of the second earpiece while the wireless headset 301 is connected together. Similarly, the USB compliant set of conductors 306 are covered by speaker 305 of the second earpiece. The gap between the two earpieces can be at least 2 mm in at least certain embodiments.

FIG. 8B shows a perspective view of the wireless headset 301 of FIG. 8A. It can be seen from this perspective view that the USB compliant set of conductors are not exposed, while they are exposed as shown in FIG. 8F when the two earpieces are separated.

FIG. 8C shows the two earpieces of FIG. 8A after they have been separated. In particular, in the side perspective view of FIG. 8C, it can be seen that USB compliant set of conductors 306 and USB compliant set of conductors 307 are now exposed and the speaker grills of speakers 304 and 305 are now exposed and can now be used by attaching each of the earpieces to an ear of a user. Alternatively, after separating the two earpieces, each of them can be charged by inserting the one end of the body containing the USB compliant set of conductors into a USB port, such as USB port 311 shown in FIG. 8D. The USB port 311 can be a USB port on a computer, or a TV, or a USB hub which is powered, or an entertainment system which includes a USB port, etc.

FIG. 8E shows a top view of the two earpieces of FIG. 8A. It can be seen from this view and from the view of FIG. 8A and the view of FIG. 8B that when the two earpieces are connected together, that the two USB sets of conductors are not exposed, while they are exposed in the perspective view shown in FIG. 8F of the earpiece which includes USB compliant set of conductors 307, which are shown in this embodiment as a set of four metallic conductors disposed near the end of body 303. It can also be seen that the end of the body 303 which includes USB compliant set of conductors 307 also includes a rounded periphery which is sized and matched to fit speaker 304. Furthermore, speaker 304 can include an outer shell which surrounds the grill but includes a cutout in the outer shell which is the same as the cutout shown in the outer shell that surrounds speaker 305 shown in FIG. 8F.

FIGS. 8G, 8H, 8I, 8J, 8K, and 8L show further different views of the second earpiece of FIG. 8A. In particular, FIG. 8G shows a perspective view of the second earpiece which includes body 303 and speaker 305 and USB compliant set of conductors 307. FIG. 8H shows an end view in which the USB compliant set of conductors 307 is closer in the view than the speaker 305. FIG. 8I shows the end view which is opposite of the end view shown in FIG. 8H, and in particular the speaker 305 is shown closer to the viewer such that the USB compliant set of conductors 307 cannot be seen in the view of FIG. 8I. FIG. 8J shows a side view of the second earpiece of FIG. 8A; FIG. 8K shows a top view of that second earpiece, and FIG. 8L shows another side view of that second earpiece.

In one embodiment, each of the earpieces shown in FIG. 8A can be mechanically and electrically identical except that one is configured to operate as the left stereo channel and the other is configured to operate as the right stereo channel, and the one that is configured to operate as the left stereo channel includes a marking such as the letter “L” on it and the other includes a marking such as “R” on it. In one embodiment, the left and right channels can also be reversed with software.

FIG. 9 shows an example of a method which can be implemented with any one of the wireless headsets that can be connected together and that have been described herein. In operation 401, the system can detect the separation of the first and second earpieces when, for example, it detects that the user has pulled apart the earpieces from their connected together state. The detection of the separation may be occurring through the use of electrical contact sensors or proximity sensors or other techniques known in the art. For example, each earpiece may include a proximity sensor which separately detects the proximity of the other earpiece. Alternatively, each earpiece may include two electrical conductors that can resistively or capacitively sense the presence of a corresponding pair of conductors on the other earpiece. In response to detecting separation of the two earpieces, a wireless headset can, in operation 403, transmit a signal from an earpiece, such as the master device earpiece to a host device to answer a telephone call or to perform some other action set by a user preference such as to cause an entertainment device to start playing music or to start operating, etc.

FIG. 10 shows another method which can be used with any one of the wireless earpieces that can be connected together, such as the earpieces 12 and 14 or the two earpieces shown in FIG. 8A. In operation 451, the system can detect the separation of the first and second earpieces, and in response to that detection, can cause both earpieces to exit their low power mode. Then the system, in operation 453, can detect that the first earpiece is now proximate to an ear. The first earpiece in this case can be the earpiece that first detects it has been attached to an ear before the other earpiece detects a similar event. This may occur through the use of an infrared sensor that detects body heat or through the use of a set of sensors such as an infrared sensor and a proximity sensor. The system can then wait, in one embodiment, for a predetermined period of time to determine whether or not the second earpiece has also been placed proximate to an ear. This is shown as operation 455. The period of time can allow a user to place the second earpiece into an ear while the second earpiece is still in a higher power mode. If, in operation 455, it has been determined that the second earpiece has been placed proximate to an ear, then one earpiece is set as the master device (typically the first earpiece in this case) and the other earpiece is set as the slave device in operation 457 and both earpieces can now be used in the stereo mode to either listen to a phone call or to listen to music or enjoy an entertainment game, etc. On the other hand, if operation 455 determines that the second earpiece has not been placed proximate to an ear, then operation 459 can result after a certain period of time. In operation 459, the first earpiece can automatically be configured to operate as a mono headset while the second earpiece is placed in a low power mode. It will be appreciated that, in one embodiment, after the second earpiece has been placed in a low power mode, it will still be possible to enter stereo mode by activating a control on the second earpiece to cause it to exit low power mode and then to signal the first earpiece that the second earpiece is operating to thereby cause entry into stereo mode.

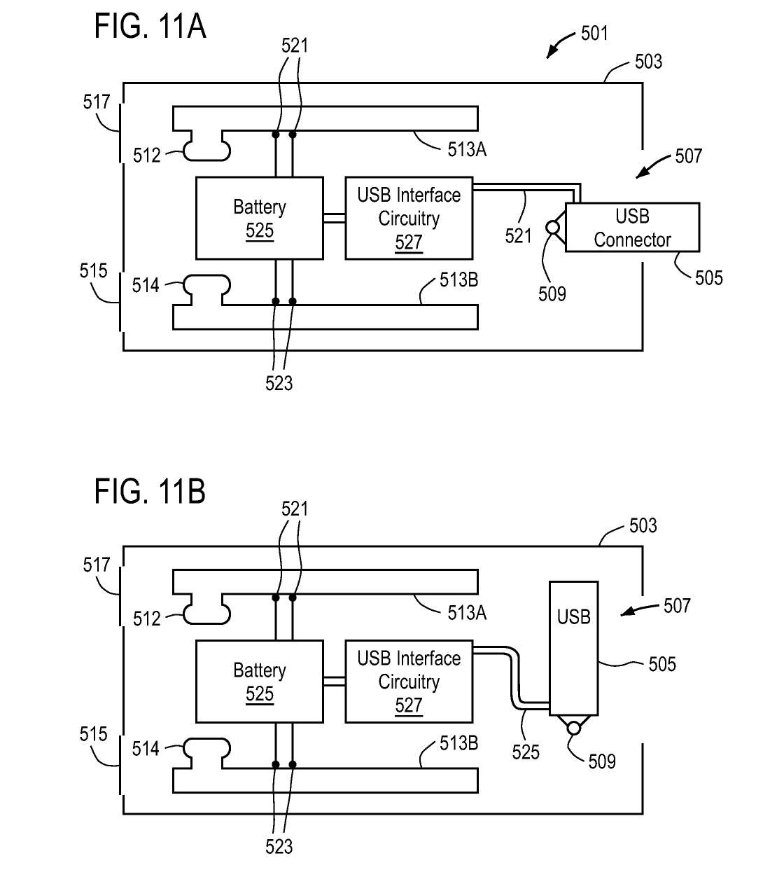

FIGS. 11A and 11B show another embodiment of the present invention in which two stereo earpieces can be stored in chambers of a housing and charged while in that housing. The earpieces can be charged through a battery contained in the housing or, if the battery is not present, through a USB interface circuitry which is coupled to a moveable USB connector.

Wireless headset system 501 includes a housing 503 that provides two chambers to removably receive and hold earpieces 513A and 513B. Openings into those chambers may be sealed with doors 515 and 517 which may slide or rotate to allow access to the chambers to remove an earpiece from the chamber and to put the earpiece back into the chamber. Each chamber may be configured to hold each earpiece in a precise configuration such that connectors 521 on earpiece 513A connect to wires from battery 525 to charge a battery within earpiece 513A and, similarly, connectors 523 on earpiece 513B connect with wires from battery 525 to charge a battery within earpiece 513B. Earpiece 513A includes a microphone and speaker 512 and earpiece 513B includes a microphone and speaker 514. Battery 525 is coupled to the USB connector 505 through USB interface circuitry 527 in order to charge battery 525 when the USB connector 505 is connected to a USB port, such as a USB port on a USB hub, or a USB port or receptacle on a computer, etc. USB interface circuitry 527 is coupled through conductors 521 to USB connector 505. The USB connector 505 is rotatably connected to housing 503 through a hinge 509 allowing the connector to rotate in and out of the housing as shown by comparing the position of USB connector 505 in FIGS. 11A and 11B. In particular, it can be seen that the USB connector 505 has rotated outwardly in FIG. 11A so that it can be connected to a USB port whereas in FIG. 11B, the USB connector 505 is rotated to be within the housing 503. It can be appreciated that opening 507 may be sealed with a door or other mechanism to close the opening when the connector 505 is within the housing as shown in FIG. 5B. In an alternative embodiment, the USB connector can slide in and out of housing 503. Battery 525 in one embodiment can be optional, in which case the batteries within each of earpieces 513A and 513B can be charged through the USB circuitry 527 when the USB connector 505 is plugged into a USB receptacle or port.

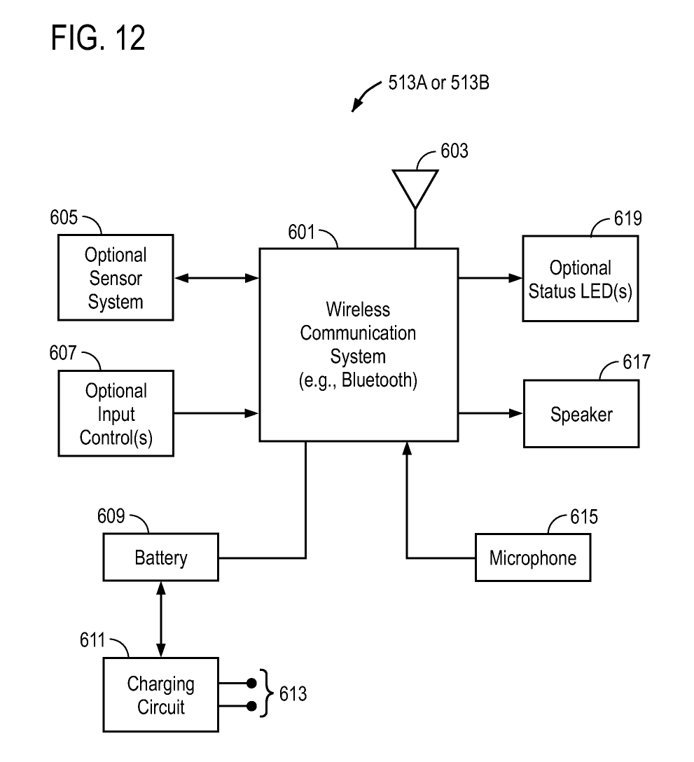

FIG. 12 shows an example of a system within one or both of earpieces 513A and 513B. The system can include a wireless communication system such as a Bluetooth chipset 601 which is coupled to the one or more antennas 603 to provide wireless communication to a host and to a second headset in the case of a master device. Battery 609 can power all components directly, including the optional input control 607 and the optional sensor system 605 in addition to the wireless communication system 601. The battery 609 is charged through a charging circuit 611 which includes connectors 613 which correspond to connectors 521 in the case of earpiece 513A or the connectors 523 in the case of earpiece 513B. The optional sensor system 605 is coupled to the system 601 and can provide similar functionality (e.g. as described in connection with FIG. 10 or FIG. 9) as the sensor system 121 of FIG. 7A. Also, the optional input control 601 can be the same as the optional input control 123 of FIG. 7A. Each of the earpieces shown in FIG. 12 can also include a speaker 617 to provide an audio output and a microphone 615 to provide an audio input, and both of these components are coupled to the wireless communication system 601. Each of these earpieces can also include an optional status LED which can be one or more LEDs 619 configured to provide an indication of the status of the earpiece.

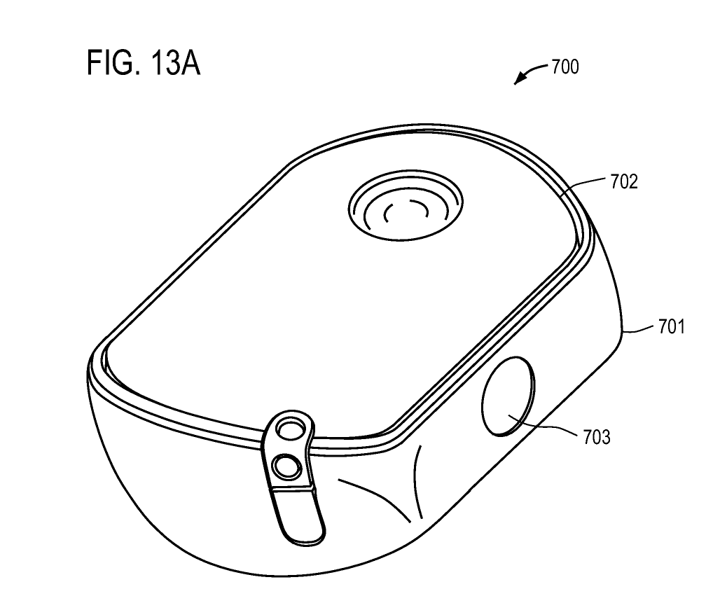

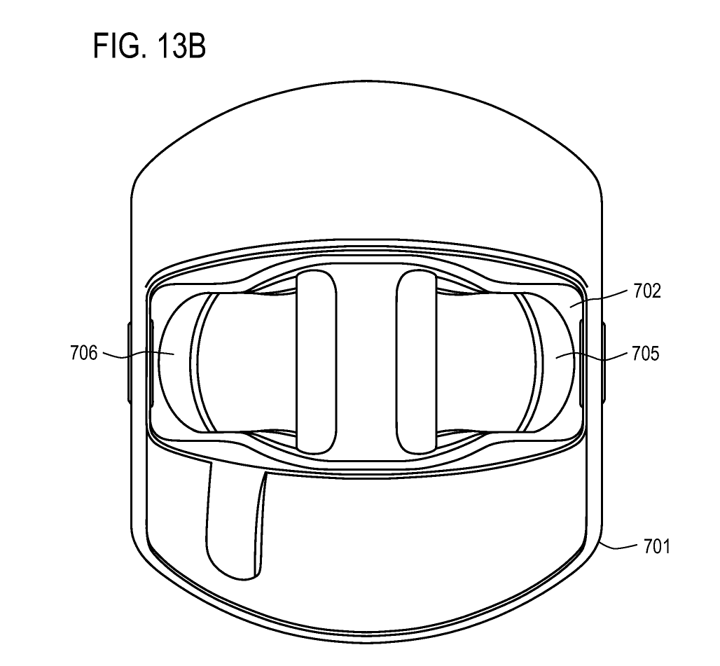

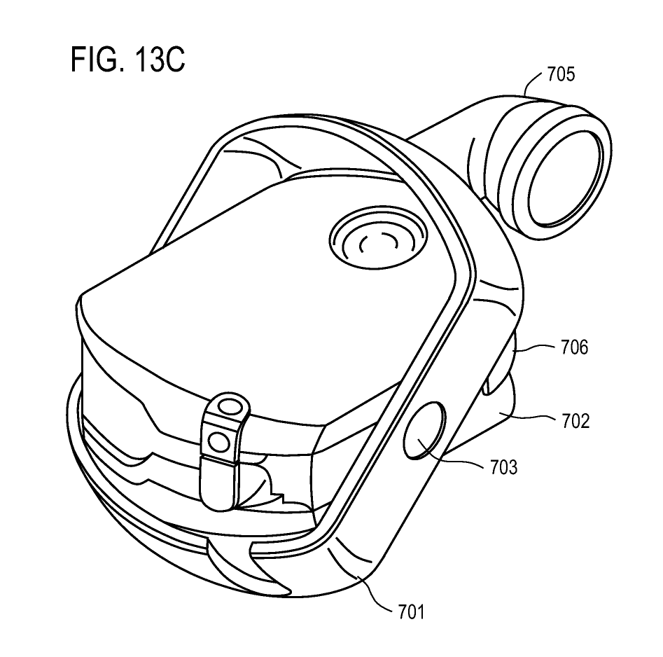

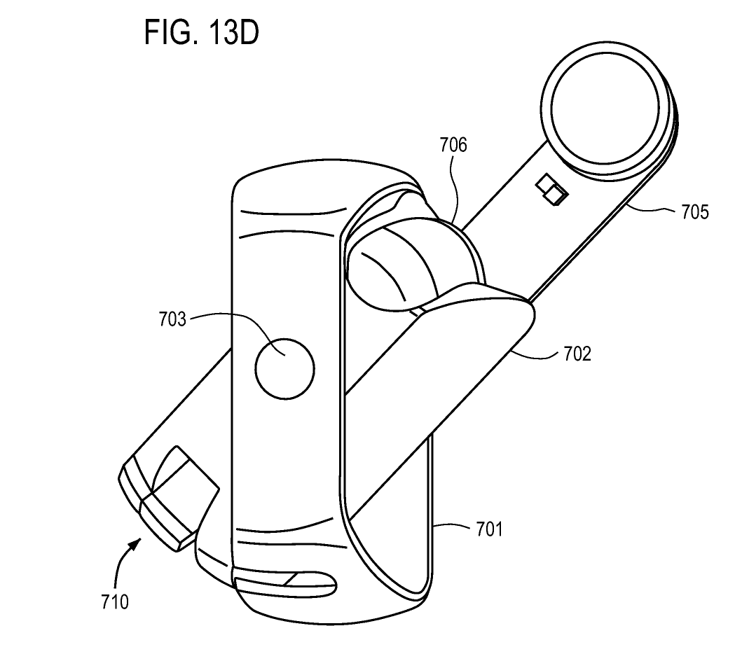

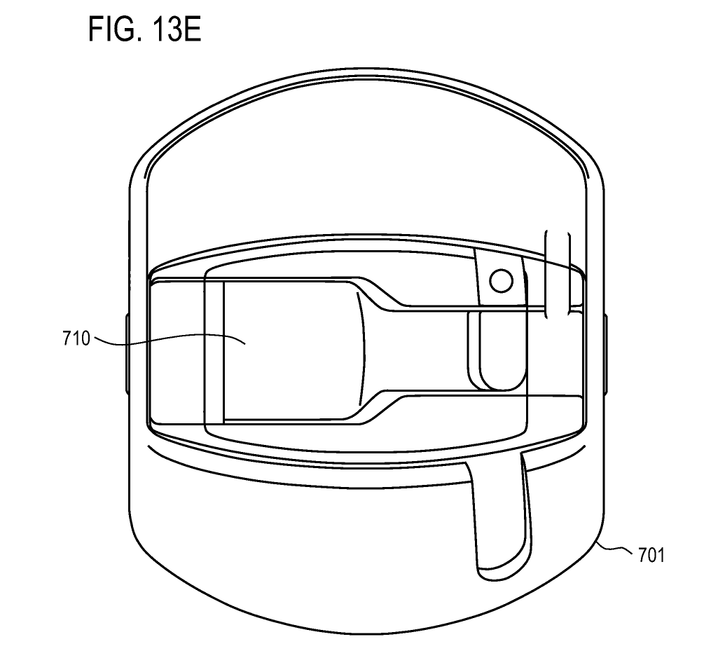

FIGS. 13A, 13B, 13C, 13D and 13E show different views of another embodiment of a wireless headset 700 that includes a pair of stereo wireless earpieces 705 and 706 that are contained within a housing 702 which includes a USB connector 710. FIG. 13A shows a perspective view of the wireless headset when the housing 702 is closed in frame 701. Housing 702 rotates on a pivot joint 703 relative to frame 701; in the view shown in FIG. 13A, the housing 702 is rotated into a closed position so that earpieces 705 and 706 are not seen. In the view of FIG. 13B, the housing 702 is rotated, on pivot joint 703, relative to frame 701 to show the earpieces 705 and 706 which are contained within one or more chambers within the housing 702. These chambers can include conductors that supply power to charge each battery within earpieces 705 and 706. FIG. 13C shows a perspective view of the wireless headset 700 after the housing 702 has been rotated relative to frame 701 to expose both earpieces 705 and 706. The earpiece 705 has been partially withdrawn from housing 702, and this can be seen from the view of FIG. 13D which also shows the end of housing 702 that exposes the USB connector 710 which is also shown in FIG. 13E.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A first earpiece of a pair of wireless stereo earpieces that includes the first earpiece and a second earpiece, the first earpiece comprising:
a body having a first end and a second end;
a speaker disposed near the first end of the body, the speaker configured to create sound from an electrical output;
a communication system configured to provide wireless communication with at least one of (a) a host or (b) the second earpiece and wherein the communication system is coupled to the speaker and to a microphone;
a battery coupled to the communication system to provide power to the communication system;
a USB (Universal Serial Bus) compliant set of connectors disposed at the second end of the body, the second end of the body being shaped and configured to matingly fit and engage a speaker of the second earpiece when the second earpiece is coupled to the first earpiece, and wherein the USB compliant set of connectors are coupled to the battery to charge the battery when the USB compliant set of connectors receive power, and wherein the USB compliant set of connectors are disposed adjacent to the speaker of the second earpiece when the second earpiece is coupled to the first earpiece.

2. The first earpiece as in claim 1 wherein the first earpiece is configured to act as a master device to receive wirelessly communication signals from the host and to transmit wirelessly signals to the second earpiece, which is configured to act as a slave device relative to the master device.

3. The first earpiece as in claim 2 wherein the first earpiece provides a first stereo channel and the second earpiece provides a second stereo channel when the first and second earpieces are configured to provide stereo sound.

4. The first earpiece as in claim 3 wherein the USB compliant set of connectors is configured to charge the battery in the first earpiece without a cable between the first earpiece and a source of power that is external to the first earpiece.

5. The first earpiece as in claim 4 wherein the source of power is a complementary set of USB connectors that, when the first earpiece is being charged, are mechanically and electrically coupled to the USB compliant set of connectors without any cable intervening between the USB compliant set of connectors and the complementary set of USB connectors.

6. The first earpiece as in claim 5 wherein the USB compliant set of connectors are disposed on one side of the second end of the body and the opposite side of the second end is a unitary component that extends from the second end to the first end of the body and wherein a unitary component of the second earpiece covers the speaker of the first earpiece such that the speaker of each earpiece is covered and the USB compliant set of connectors of each earpiece is covered when the first earpiece and the second earpiece are joined.

7. The first earpiece as in claim 5 wherein the USB compliant set of connectors complies at least partially with at least USB connector type A of the USB 2.0 standard, and wherein the first earpiece and the second earpiece, when mechanically joined together, form a gap between the first and the second earpieces.

8. The first earpiece as in claim 5 further comprising:
a first magnet configured to be attracted to at least one of a second magnet or a ferrous object or another magnetically attracted material in the second earpiece when the first earpiece and the second earpiece are joined together.

9. The first earpiece as in claim 8 further comprising:
a visual indicator disposed on the body, the visual indicator being configured to indicate at least one of (a) the state of charge of the battery and (b) the operating condition of the first earpiece.

10. The first earpiece as in claim 5 wherein the second end of the body adjacent to the USB compliant set of connectors has a rounded edge at the periphery of the second end of the body.

11. The first earpiece as in claim 10 wherein the rounded edge at the periphery of the second end of the body is matched in size and shape to a round contour of a speaker of the second earpiece.

12. The first earpiece as in claim 5 further comprising:
a sensor configured to sense when the first earpiece is attached to an ear, the sensor disposed in the body, the sensor coupled to the communication system to allow the second earpiece to remain in a low power state if a sensor in the second earpiece detects that the second earpiece is not attached to an ear.

13. The first earpiece as in claim 5 further comprising:
an electrically erasable semiconductor memory device coupled to the USB compliant set of connectors.

14. A stereo wireless headset comprising:
a first earpiece having a first body, a first speaker, a first battery, a first communication system and a first USB (Universal Serial Bus) compliant set of connectors;
a second earpiece having a second body, a second speaker, a second battery, a second communication system and a second USB compliant set of connectors;
wherein the first USB compliant set of connectors is configured to charge the first battery without a cable to directly connect the first earpiece to a power source that is external to the first earpiece; and
wherein the second USB compliant set of connectors is configured to charge the second battery without a cable to directly connect the second earpiece to a power source that is external to the second earpiece; and
wherein the first earpiece and the second earpiece are shaped and configured to matingly engage together such that the first speaker mates with a portion of the second earpiece having the second USB compliant set of connectors and the second speaker mates with a portion of the first earpiece having the first USB compliant set of connectors.

15. The stereo wireless headset as in claim 14 wherein the first USB compliant set of connectors and the second USB compliant set of connectors are male plugs that include at least two USB compliant conductors that are spaced apart from each other and are sized to comply with a USB standard and have a shape and size defined at least in part by the USB connector type A.

16. The stereo wireless headset as in claim 15 wherein the first earpiece is configured to act as a master device to receive wirelessly communication signals from a host and is configured to transmit wirelessly signals to the second earpiece, which is configured to act as a slave device relative to the master device and wherein the first earpiece provides a first stereo channel and the second earpiece provides a second stereo channel when the first and the second earpieces are configured to provide stereo sound.

17. The stereo wireless headset as in claim 16 wherein the source of power is a complementary set of USB connectors that, when the first earpiece is being charged, are mechanically and electrically coupled to the first USB compliant set of connectors without any cable intervening between the first USB compliant set of connectors and the complementary set of USB connectors.

18. The stereo wireless headset as in claim 17 wherein the first earpiece and the second earpiece, when mechanically joined together, form a gap between the first and the second earpieces.

19. The stereo wireless headset as in claim 17 further comprising:
a first magnet attached to the first earpiece;
a second magnet or ferrous object attached to the second earpiece, the first magnet and the second magnet or ferrous object having a size and strength and relative location to be attracted to each other with sufficient force to hold the first earpiece and the second earpiece together.

20. The stereo wireless headset as in claim 17 further comprising:
a first visual indicator disposed on the first earpiece, the first visual indicator being configured to indicate at least one of (a) the state of charge of the first battery and (b) the operating condition of the first earpiece; and
a second visual indicator disposed on the second earpiece, the second visual indicator being configured to indicate at least one of (a) the state of charge of the second battery and (b) the operating condition of the second earpiece.

21. The stereo wireless headset as in claim 17 wherein a first end of the first body includes the first USB compliant set of connectors and has a first rounded edge at the periphery of the first end, and wherein a second end of the second body includes the second USB compliant set of connectors and has a second rounded edge at the periphery of the second end, and wherein the first rounded edge is matched in size and in shape to a round contour of the second speaker and wherein the second rounded edge is matched in size and in shape to a round contour of the first speaker.

22. The stereo wireless headset as in claim 17 further comprising:
a first sensor attached to the first body, the first sensor configured to sense when the first earpiece is attached to an ear, the first sensor being coupled to the first communication system to allow the second earpiece to remain in a low power state if a second sensor in the second earpiece detects that the second earpiece is not attached to an ear.

23. The stereo wireless headset as in claim 21 wherein when the first earpiece and the second earpiece are joined together, the first speaker covers the second USB compliant set of connectors such that the second USB compliant set of connectors are not exposed and the second speaker covers the first USB compliant set of connectors such that the first USB compliant set of connectors are not exposed, and wherein when the first earpiece and the second earpiece are pulled apart and separated, the first USB compliant set of connectors and the second USB compliant set of connectors are exposed.

24. The stereo wireless headset as in claim 17 further comprising:
an electrically erasable semiconductor memory device coupled to the first USB compliant set of connectors.

25. A method of using a wireless stereo headset having a pair of earpieces comprising a first earpiece and a second earpiece, the method comprising:
connecting together the first earpiece and the second earpiece, the first earpiece having a first speaker and a first USB (Universal Serial Bus) compliant set of conductors, and the second earpiece having a second speaker and a second USB compliant set of conductors, the first speaker covering the second USB compliant set of conductors when the first and the second earpieces are connected together, and the second speaker covering the first USB compliant set of conductors when the first and the second earpieces are connected together;
separating the first earpiece and the second earpiece, wherein the separating exposes the first USB compliant set of conductors and the second USB compliant set of conductors.

26. The method as in claim 25 wherein when the first earpiece and the second earpiece are connected together, the first and the second earpieces are held together by at least one of (a) a frictional fit and (b) a first magnet and at least one of a second magnet or a ferrous object or other magnetically attracted material.

27. The method as in claim 26 wherein a gap is formed between the first and second earpieces when the first earpiece and the second earpiece are connected together and wherein the gap is greater than 2 mm.

28. The method as in claim 27 wherein the first earpiece comprises a first battery and wherein the first USB compliant set of conductors is configured to charge the first battery without a cable between the first earpiece and a source of power that is external to the first earpiece and wherein the second earpiece comprises a second battery and wherein the second USB compliant set of conductors is configured to charge the second battery without a cable between the second earpiece and a source of power that is external to the second earpiece.

29. The method as in claim 28 wherein the first earpiece comprises a first elongate body coupled to the first speaker and extending from the first speaker to the first USB compliant set of conductors, and wherein the first elongate body has a first side on which the first speaker and the first USB compliant set of conductors are disposed and a second side which is opposite the first side and which does not include the first USB compliant set of conductors and wherein when the first speaker is attached to an ear, the first side is next to a user's face and the second side is facing away from the user's face; and
wherein the second earpiece comprises a second elongate body coupled to the second speaker and to the second USB compliant set of conductors, the second elongate body extending between the second speaker and the second USB compliant set of conductors, and wherein the second elongate body has a third side on which the second speaker and the second USB compliant set of conductors are disposed and a fourth side which is opposite the third side and which does not include the second USB compliant set of conductors, and wherein when the second speaker is attached to an ear, the third side is next to a user's face and the fourth side is facing away from the user's face.

30. The method as in claim 29 wherein a first end of the first elongate body includes the first USB compliant set of conductors and has a first rounded edge at a periphery of the first end, and wherein a second end of the second elongate body includes the second USB compliant set of conductors and has a second rounded edge at a periphery of the second end, and wherein the first rounded edge is matched in size and in shape to a round contour of the second speaker, and wherein the second rounded edge is matched in size and in shape to a round contour of the first speaker and wherein an electrically erasable semiconductor memory is coupled to the first USB compliant set of conductors.

31. The method as in claim 30 wherein the first earpiece comprises a first visual indicator that is configured to indicate at least one of (a) an operational state of the first earpiece and (b) a charge status of the first battery; and wherein the second earpiece comprises a second visual indicator that is configured to indicate at least one of (a) an operational state of the second earpiece and (b) a charge status of the second battery.

32. A method of a wireless stereo headset having a pair of earpieces comprising a first earpiece and a second earpiece, the method comprising:
detecting a separation of the first earpiece and the second earpiece from a state in which the first earpiece and the second earpiece were connected together; and
changing a state of at least one of the first and the second earpieces in response to detecting the separation.

33. The method as in claim 32 wherein the changing of a state comprises waking up the at least one of the first and the second earpieces to cause a telephone to be answered and to use the at least one of the first and the second earpieces as an earpiece for the telephone or to play audio from a host device.

34. The method as in claim 32, wherein the method further comprises:
detecting, after the separation, that the first earpiece has been attached to an ear;
determining whether the second earpiece has been attached to an ear;
setting automatically the first earpiece to act as a mono headset while the second earpiece is placed in a low power state in response to determining that the second earpiece has not been attached to an ear after detecting the separation; and
setting automatically the first and the second earpieces to operate in stereo mode in response to determining that the second earpiece has been attached to an ear after detecting the separation.

35. The method as in claim 34 wherein the detecting that the first earpiece has been attached to an ear is performed with at least one of (a) a first pressure sensor to sense a pressure from an ear on a first speaker of the first earpiece and (b) a first proximity sensor to sense the first earpiece is proximate to an ear, and (c) a first ambient light sensor and (d) an infrared sensor.

36. The method as in claim 35 wherein the determining of whether the second earpiece has been attached to an ear is performed with at least one of (a) a second pressure sensor to sense a pressure from an ear on a second speaker of the second earpiece and (b) a second proximity sensor to sense the second earpiece is proximate to an ear, and (c) a second ambient light sensor.

37. The method as in claim 36 wherein the detecting a separation is performed with the first proximity sensor and the second proximity sensor.

38. The method as in claim 34 wherein the low power state is a standby mode from which the second earpiece is awakened in response to detecting that the second earpiece has been attached to an ear.

39. The method as in claim 38 further comprising:
setting the first earpiece as a master device and the second earpiece as a slave device, wherein the master device communicates wirelessly and bi-directionally with a host and communicates with the slave device such that signals from the host destined for the slave device pass through the master device.

40. The method as in claim 39 wherein the second earpiece, in response to determining that the second earpiece has been attached to an ear, transmits a signal to the first earpiece to cause a switch from mono mode to stereo mode and the second earpiece exits the low power state.

41. The method as in claim 40 wherein when the first earpiece and the second earpiece are connected together, a first speaker of the first earpiece mates with a second USB compliant set of conductors of the second earpiece and a second speaker of the second earpiece mates with a first USB compliant set of conductors of the first earpiece and wherein when the first earpiece and the second earpiece are connected together, the first and the second earpieces are held together by at least one of (a) a frictional fit between the earpieces and (b) a first magnet and at least one of a second magnet or a ferrous object or other magnetically attracted object.

42. The method as in claim 41 wherein after detecting the separation, the first earpiece and the second earpiece both exit a low power mode to detect whether either is attached to an ear and wherein the first of the pair to be attached to an ear becomes the master device and the other of the pair becomes the slave device and wherein the slave device enters the low power mode after a period of time in which the slave device has not been attached to an ear and wherein an electrically erasable semiconductor memory is coupled to the first USB compliant set of conductors.

43. A stereo wireless headset comprising:
a housing having a first chamber and a second chamber;
a USB (Universal Serial Bus) compliant connector moveably coupled to the housing;
a first earpiece removably disposed within the first chamber, the first earpiece having a first battery and a first set of connectors configured to receive power to recharge the first battery while the first earpiece is within the first chamber; and
a second earpiece removably disposed within the second chamber, the second earpiece having a second battery and a second set of connectors configured to receive power to recharge the second battery while the second earpiece is within the second chamber.

44. The stereo wireless headset as in claim 43, further comprising:
a third battery attached to the housing and electrically coupled to the USB compliant connector to be charged by power received through the USB compliant connector and electrically coupled to the first set of connectors to charge the first battery when the first earpiece is disposed in the first chamber and electrically coupled to the second set of connectors to charge the second battery when the second earpiece is disposed in the second chamber.

45. The stereo wireless headset as in claim 44 further comprising:
a charging circuit coupled to the USB compliant connector and to the third battery and optionally coupled to the first battery and to the second battery when the first earpiece and the second earpiece is disposed respectively with the first and the second chambers.

46. The stereo wireless headset as in claim 45 wherein the USB compliant connector is rotatably coupled to the housing such that it rotates in or out of the housing.

47. The stereo wireless headset as in claim 45 wherein the USB compliant connector is slideably coupled to the housing such that it slides in and out of the housing.

48. The stereo wireless headset as in claim 45 wherein the charging circuit charges the third battery, and the third battery charges the first battery and the second battery.

49. The stereo wireless headset as in claim 48 wherein the USB compliant connector charges the third battery without a cable between the USB compliant connector and a source of power external to the stereo wireless headset.

50. The stereo wireless headset as in claim 49 wherein each of the first earpiece and the second earpiece is configured to be used in a mono mode after being removed from one of the first and the second chambers while the other of the first and the second earpieces remains in a low power mode within the other of the first and the second chambers.

51. The stereo wireless headset as in claim 50 wherein each of the first earpiece and the second earpiece is configured to turn on and to answer a host telephone when removed from its respective one of the first and the second chambers.

52. The stereo wireless headset as in claim 49 wherein each of the first earpiece and the second earpiece is configured to be used in a mono mode after being removed from one of the first and the second chambers while the other of the first and the second earpieces initially remains in a low power mode within the other of the first and the second chambers and after the other of the first and the second earpieces is removed from its chamber then the first and the second earpieces are automatically switched to stereo mode.

53. The stereo wireless headset as in claim 52 wherein each of the first earpiece and the second earpiece is configured to turn on and to answer a host telephone in response to being removed from its respective one of the first and the second chambers.

54. The stereo wireless headset as in claim 53 wherein each of the first earpiece and the second earpiece is configured to act as a master device to communicate wirelessly and bi-directionally with the host telephone and the other of the first earpiece and the second earpiece is configured to act as a slave device to receive communications from the host telephone through the master device.

55. The stereo wireless headset as in claim 54 further comprising:
an electrically erasable semiconductor memory device coupled to the USB compliant connector.

56. A stereo wireless headset comprising:
a first earpiece having a first body, a first speaker, a first microphone, a first battery and a first communication system;
a second earpiece having a second body, a second speaker, a second microphone, a second battery, and a second communication system;
wherein each of the first communication system and the second communication system is configured to act as a master device or a slave device such that when the first communication system is the master device then the second communication system is the slave device in a binaural mode and when the second communication system is the master device then the first communication system is the slave device in the binaural mode.

57. The stereo wireless headset is in claim 56 wherein each of the first earpiece and the second earpiece is configured to operate as a mono channel device without the other earpiece, when the other earpiece is not used.

58. The stereo wireless headset as in claim 56 wherein the first earpiece and the second earpiece are identical except that one is configured to operate as a left stereo channel and the other is configured to operate as a right stereo channel.

59. The stereo wireless headset as in claim 56 wherein the first earpiece comprises a first sensor coupled to the first communication system and the second earpiece comprises a second sensor coupled to the second communication system, and wherein the first earpiece and the second earpiece are paired to operate according to a Bluetooth standard and wherein the first communication system is configured to cause the first earpiece, in response to a signal from the first sensor, to become the master device when the first communication system becomes the master device, and wherein the second communication system is configured to cause the second earpiece, in response to a signal from the second sensor, to become the master device when the second communication system becomes the master device.

60. The stereo wireless headset as in claim 59 wherein when the second earpiece is not available the first microphone provides an audio input to a host and when the first earpiece is not available the second microphone provides the audio input to the host.

61. The stereo wireless headset as in claim 60 wherein the first earpiece comprises a first USB compliant set of conductors that are coupled to the first battery to charge the first battery without a cable between the first earpiece and a source of power that is external to the first earpiece, and wherein the second earpiece comprises a second USB compliant set of conductors that are coupled to the second battery to charge the second battery without a cable between the second earpiece and a source of power that is external to the second earpiece.
